(19) United States
(12) Patent Application Publication
(10) Pub. No.: US 2026/0178615 A1
(43) Pub. Date: Jun. 25, 2026

(54) PARAMETER BASED SUB-DATABASE REPLICATION

(71) Applicant: Snowflake Inc., Bozeman, MT (US)

(72) Inventors: Harminter Singh Atwal, Bothell, WA (US); Nithin Mahesh, Kirkland, WA (US); Zhen Mo, Cupertino, CA (US); Siddarth Ramadoss, Kirkland, WA (US); Sahaj Saini, Seattle, WA (US); Subramanian Sankara Subramanian, Mercer Island, WA (US)

(21) Appl. No.: 18/989,704

(22) Filed: Dec. 20, 2024

(51) Int. Cl. G06F 16/27; G06F 16/23; G06F 16/28

(52) U.S. Cl. CPC G06F 16/275; G06F 16/2365; G06F 16/282

(57) ABSTRACT

A data platform is provided that stores a hierarchical database including a database object and a set of child objects in a hierarchical parent-child structure, configures a respective replicable parameter of a set of replicable parameters for the database and each child object within the hierarchical database, and selectively replicates a set of objects of the database between accounts while maintaining data consistency during replication using the set of replicable parameters. The data platform implements parameter-based replication by introducing a customer-visible parameter that can be set at both database and child object levels, with child objects automatically inheriting replication settings from their parents unless explicitly overridden. The data platform maintains data consistency by checking domain support before replication, tracking inheritance relationships, and preserving non-replicated objects during failover operations unless specific conflicts exist.

### TECHNICAL FIELD

Examples of the disclosure relate generally to data platforms and, more specifically, to database replication.

### BACKGROUND

Data platforms are widely used for data storage and data access in computing and communication contexts. With respect to architecture, a data platform can be an on-premises data platform, a network-based data platform (e.g., a cloud-based data platform), a combination of the two, and/or include another type of architecture. With respect to type of data processing, a data platform can implement online transactional processing (OLTP), online analytical processing (OLAP), a combination of the two, and/or another type of data processing. Moreover, a data platform can be or include a relational database management system (RDBMS) and/or one or more other types of database management systems. Cloud-based data platforms may communicate data between databases.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider user system, according to some examples.

FIG. 2 is a block diagram illustrating components of a compute service manager, according to some examples.

FIG. 3 illustrates a database replication method, according to some examples.

FIG. 4A and FIG. 4B illustrate a primary-side replication method, according to some examples.

FIG. 5A and FIG. 5B illustrate a secondary-side replication method, according to some examples.

FIG. 6, illustrates a refresh of a primary database having replicable parameters, according to some examples.

FIG. 7 illustrates a failover refresh of a primary database having replicable parameters, according to some examples.

FIG. 8A and FIG. 8B illustrate failover group refresh and failover group refresh back properties of replicable parameters, according to some examples.

FIG. 9 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms are widely used for data storage and data access in computing and communication contexts. Current database replication systems force organizations to replicate entire databases even when only specific portions need to be replicated for disaster recovery purposes. This creates significant business challenges where organizations either accept unnecessary costs and latency from replicating excess data or undertake expensive database reorganization projects to isolate replication-necessary data. The lack of granular replication control particularly affects enterprises that need to selectively replicate collaboration spaces while excluding user spaces or replicate production data while excluding staging data.

When implementing database replication across distributed systems, organizations face additional challenges around maintaining data consistency and managing replication configurations. Some current solutions require replicating entire databases even when only specific schemas or tables need disaster recovery protection. This approach creates inefficiencies where organizations must replicate unnecessary data or invest significant resources in database restructuring. The inability to selectively replicate at a granular level leads to increased costs, higher latency, and more complex database management.

The methodologies and systems described in this disclosure provide a parameter-based sub-database replication system that enables granular control over database replication through an inheritable replication parameter. These methodologies use a replicable parameter that can be set at both database and child object levels, with child objects automatically inheriting replication settings from their parents unless explicitly overridden.

In some examples, the methodologies include replication through a two-sided approach—on the primary side, snapshots are created using a top-down traversal of the database hierarchy, selectively including objects based on their replication parameter values. On a secondary side, objects are synchronized by mapping Global Object References between accounts and handling object creation, deletion, and renaming while maintaining parameter-based replication rules. In some examples, to prevent unauthorized modifications, an account-level replicate privilege is required for replicable parameter changes, ensuring centralized control over replication configurations.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

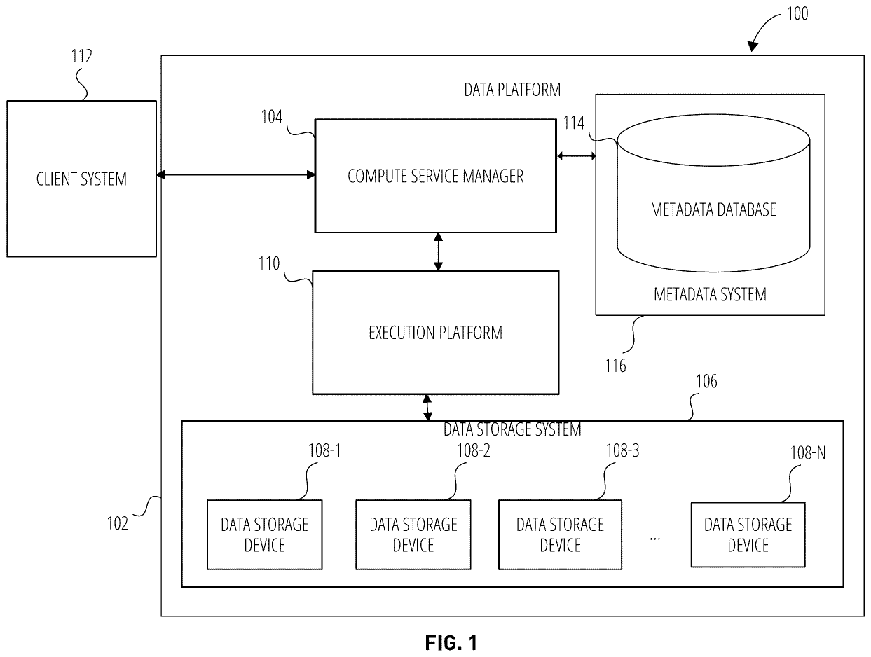

FIG. 1 illustrates an example computing environment 100 that includes a data platform 102 in communication with a client system 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage system 106, a compute service manager 104, an execution platform 110, and a metadata system 116. The data storage system 106 comprises a plurality of computing machines and provides on-demand computer system resources such as data storage and computing power to the data platform 102. As shown, the data storage system 106 comprises multiple data storage devices, such as data storage device 108-1, data storage device 108-2, data storage device 108-3, and data storage device 108-N. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage system 106 may include distributed file systems (e.g., Hadoop Distributed File Systems (HDFS)), object storage systems, and the like.

In some examples, one or more of the data storage devices 108-1 to 108-N are cloud-based datastores configured as Virtual Private Clouds (VPCs). In some examples, a VPC is a secure, isolated virtual network within a public cloud environment that allows organizations to run and manage their cloud resources with enhanced control and privacy. A VPC can provide the functionality of a traditional data center without the physical management and maintenance overhead, enabling users to define their own network space. This includes selecting IP address ranges, creating subnets, configuring route tables, and setting up network gateways. VPCs are beneficial for objects that desire a partitioned section of the cloud to ensure that their applications and data are isolated from other users on the same public cloud platform. This isolation helps in maintaining security and compliance with regulatory requirements, while also allowing for scalable and flexible resource management.

In some examples, data objects are stored in structured data files. The structured data files can be in various structured file formats such as, but not limited to, Comma-Separated Values (CSV) JavaScript Object Notation (JSON), Apache Avro (Avro), Apache Parquet (Parquet) Optimized Row Columnar (ORC), Extensible Markup Language (XML), and the like.

In some examples, the data platform 102 organizes data storage using micro-partitions of a database table using a suitable structured data file format specifically designed for optimal performance and security within the computing environment 100 such as, but not limited to, Flocon De Neige (FDN) and the like. Whenever new data is added to a table, new micro-partition files are created. This approach ensures that data is stored in an immutable format where the addition of a new record results in the generation of a new micro-partition file.

The data platform 102 is used for reporting and analysis of integrated data from one or more disparate sources including the storage devices 1 to N within the data storage system 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage system 106. Moreover, the data platform 102 may maintain metadata associated with the consumer accounts in the metadata database 114 of the metadata system 116. Each consumer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client system 112. The client system 112 can be used by a user of one of the multiple consumer accounts supported by the data platform 102 to interact with and utilize the functionality of the data platform 102.

In some examples, the compute service manager 104 does not receive any direct communications from the client system 112 and only receives communications concerning jobs from a queue within the data platform 102.

The compute service manager 104 is also coupled to metadata database metadata system 116. The metadata system 116 includes a metadata database 114 that stores metadata pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the data storage system 106) and the local caches. In some examples, the metadata database 114 include data of metrics describing usage and access by provider users and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the data storage system 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 108-1 to data storage device 108-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata system 116, execution platform 110, and data storage system 106 are shown in FIG. 1 as individual discrete components. However, each of the compute service manager 104, metadata system 116, execution platform 110, and data storage system 106 may be implemented as a distributed system (e.g., distributed across multiple systems/platforms at multiple geographic locations). Additionally, each of the compute service manager 104, metadata system 116, execution platform 110, and data storage system 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage system 106. It is desirable to retrieve as much data as possible from caches within the execution platform 110 because the retrieval speed is typically faster than retrieving data from the data storage system 106.

As shown in FIG. 1, the computing environment 100 separates the execution platform 110 from the data storage system 106. In this arrangement, the processing resources and cache resources in the execution platform 110 operate independently of the database storage devices data storage device 108-1 to data storage device 108-N in the data storage system 106. Thus, the computing resources and cache resources are not restricted to a specific one of the data storage device 108-1 to data storage device 108-N. Instead, computing resources and cache resources may retrieve data from, and store data to, any of the data storage resources in the data storage system 106.

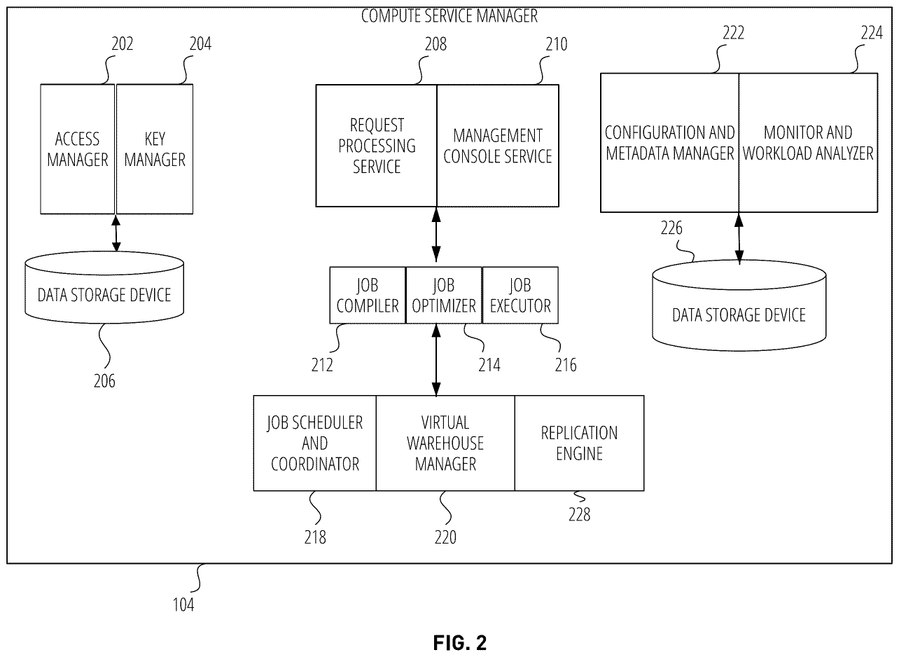

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage data storage device 206). As used herein, the remote storage devices may also be referred to as “persistent storage devices” or “shared storage devices.”

In some examples, the access manager 202 operates within a data platform to control access to various objects of the data platform using Role-Based Access Control (RBAC). The access manager 202 is a component that manages authentication and authorization tasks, providing for authorized objects to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that objects assigned to the role can perform on various objects within the data platform. The access manager 202 utilizes these roles to make access control decisions, allowing or denying requests based on the roles assigned to the requesting object and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or objects authorized by the application, can perform actions permitted by the access role.

In some examples, the access manager 202 also controls access to objects of the data platform using the access roles during the execution of the service within the compute pool. The service accesses objects of the application package and of the data platform under the governance of the activated access roles. The access manager 202 checks the permissions associated with the access roles against the access requests made by the service, granting or denying these requests based on the defined RBAC policies.

In some examples, the role of the access manager 202 extends to managing access to hidden repositories within a provider account, where the application package is stored. The access manager 202 uses RBAC to restrict access to a hidden repository, providing for the application package to be accessible to objects with the appropriate access role. This mechanism protects the application package from unauthorized access, preserving the integrity of the provider's intellectual property.

In some examples, the access manager 202 implements RBAC to isolate the compute pool, preventing the service from accessing other services or resources not specified in the application package. This isolation is achieved by defining access roles that explicitly limit the service's permissions to the resources provided for the operation of the service, thereby enhancing the security of the service execution environment.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage system 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job.

The job executor 216 is a component of the compute service manager 104 that executes the execution code for jobs received from a queue or determined by the compute service manager. It works in conjunction with other components like the job compiler 212 and job optimizer 214 to process jobs within the data platform. The job executor 216 is responsible for carrying out the actual execution of compiled and optimized jobs, utilizing the resources of the execution platform 110 to perform data storage and retrieval tasks.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage system 106, or any other storage device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node may need to communicate with another execution node, and should be disallowed from communicating with a third execution node and any such illicit communication can be recorded (e.g., in a log or other location). Also, the information stored on a given execution node is restricted to data relevant to the current query and any other data is unusable, rendered so by destruction or encryption where the key is unavailable.

In some examples, the compute service manager 104 includes a replication engine 228 used to perform replication of objects within the data platform. The replication engine 228 coordinates the end-to-end replication process across distributed database systems as more fully described in

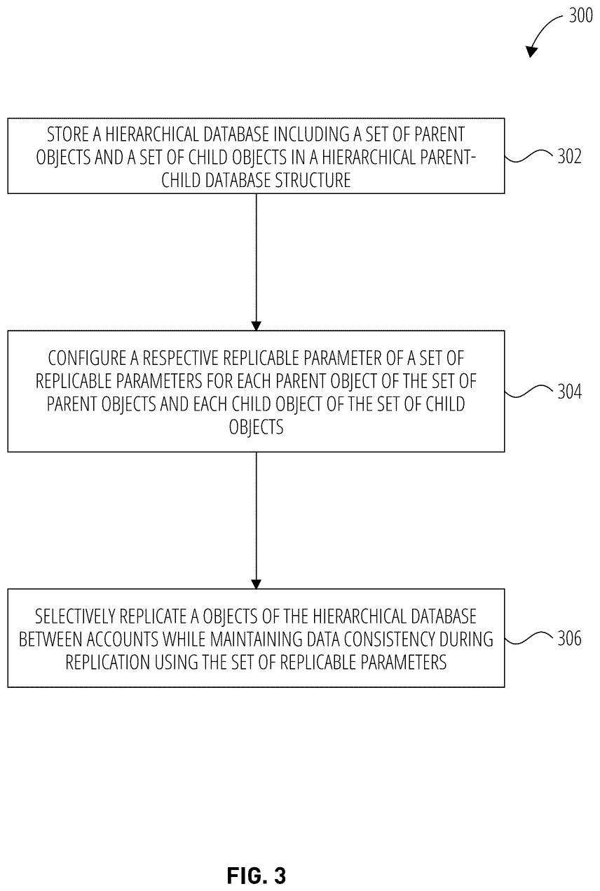

FIG. 3 illustrates an example database replication method 300 for replicating all or a portion of a database using a replication engine. Although the example database replication method 300 depicts a particular sequence of operations, the sequence may be altered without departing from the scope of the present disclosure. For example, some of the operations depicted may be performed in parallel or in a different sequence that does not materially affect the function of the database replication method 300. In other examples, different components of a data platform 102 that implements the database replication method 300 may perform functions at substantially the same time or in a specific sequence.

In operation 302, a compute service manager 104 (of FIG. 1) stores a hierarchical database including a database having a set of child objects in a hierarchical parent-child structure. For example, the compute service manager 104 stores a hierarchical database by storing database objects in a data storage system 106 (of FIG. 1) while generating and maintaining metadata stored in metadata system 116 (of FIG. 1) describing the database objects in a structured parent-child relationship within the data storage system 106.

In some examples, the metadata can be used to track object relationships and lineages of the objects of the hierarchal database. The metadata can include respective replicable parameters for objects that can be replicated.

In operation 304, the compute service manager 104 configures a respective replicable parameter of a set of replicable parameters for the database and each child object of the set of child objects. The replicable parameters can be set at a database level and a child object level within the hierarchical database. For example, the compute service manager 104 configures replicable parameters using a customer-visible parameter that can be set by a user and that can be propagated using a set of hierarchy rules. A replication engine 228 (of FIG. 2) uses replicable parameters to provide for selective replication of specific database objects while maintaining the overall database structure and relationships.

In some examples, setting a replicable parameter enables replication only within failover groups, thus the replicable parameters have no impact on database refresh or replication through replication groups. Failover refers to the automatic switching of database operations from a primary system to a secondary backup system when the primary system fails or becomes unavailable. This process helps maintain continuous database accessibility and minimize downtime. A failover group is a collection of databases that can be managed and failed over as a unit. A failover group enables automated switching of database operations between primary and secondary accounts through parameter-based replication control.

In some examples, a replicable parameter is settable at a database level and all child object levels allowing the replicable parameter to control which database objects are replicated during failover operations. In some examples, if a value is set for a replicable parameter at the database level, all child objects of the database will inherit the replicable parameter value unless explicitly overridden on the child object.

In some examples, a replicable parameter can have a set of values with each value representing a permitted action during replication such as, but not limited to, a YES value, a NO value, an UNSET value, and the like.

For example, a replicable parameter set to YES indicates that the database object should be replicated as part of group operations. When set to YES, either explicitly or inherited from a parent object, the object will be included in replication operations. In some examples, if the replicable parameter is set to YES on a child object while the parent database has a replicable parameter set to NO, the child object will be replicated. In some examples, when a child object inherits a YES value for the replicable parameter from its parent, it will be replicated along with the parent unless the value of the replicable parameter of the child object is explicitly set to NO.

In some examples, a replicable parameter set to NO at a primary database level indicates that a database object and its child objects should not be replicated as part of failover group operations. For example, when set to NO at the database level, all replicable parameters of child objects automatically inherit this value unless explicitly overridden with a YES value in the replicable parameter of the child object. Child objects can override a parent's NO value by explicitly setting their replicable parameter to YES, allowing selective replication of specific child objects within a non-replicating database.

In some examples, objects with a replicable parameter set to NO are excluded from replication snapshots unless they contain child objects having a replicable parameter set to YES. This may present a performance issue as an entire hierarchy of an object may need to be traversed to determine if the object includes a child object that has a replicable parameter set to YES. To address this potential performance issue of traversing all child objects, a data platform uses a replicable children count property in a Data Persistence Object (DPO) that provides an optimization mechanism for replication decisions. This replicable children count property tracks a count of child objects that have replicable parameters set to YES within each database. This optimization is useful for large primary databases with thousands of child objects such as schemas, as it eliminates the need to traverse all child objects when the primary database has a replicable parameter set to NO and no child objects have a replicable parameter set to YES. When executing a replication operation, a replication engine 228 can check the replicable children count value first and skip the entire traversal if the replicable children count property value is zero, improving performance for these scenarios.

In some examples, the replicable children count property is dynamically updated whenever a child object sets its replicable parameter to YES. By maintaining this replicable children count property at the database level, the replication engine 228 can quickly determine whether any child objects need to be replicated without having to traverse an entire hierarchy of a database.

In some examples, when the replication engine 228 determines the count of child objects is equal to zero, the 228 replicates a database without replicating any of the child objects of a set of child objects. In response to determining the count of child objects is one or more, the replication engine 228 replicates the database while replicating one or more data objects of a set of data objects based on their respective replicable parameters.

In some examples, a replication behavior of the replicable children count property is permitted to be copied to ensure consistency between primary and secondary accounts during synchronization. Since all objects with a replicable parameter set to YES are involved in synchronization, the replicable children count property remains identical across both accounts.

In some examples, to maintain data integrity, a system replicable count reset function is provided that takes an account ID and a primary database name as input parameters. This function allows recalculation of the replicable children count property for a database and its child objects if any inconsistencies arise.

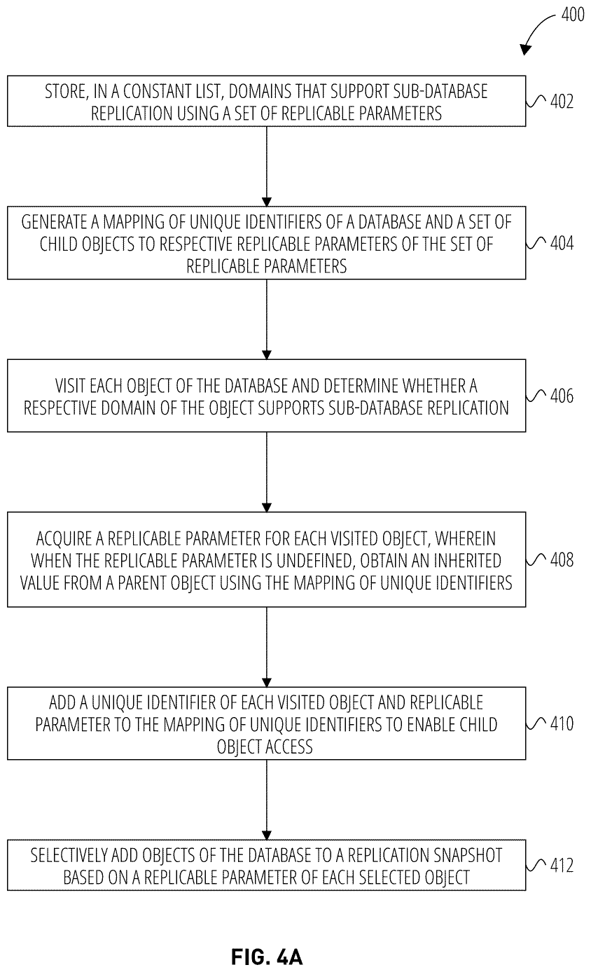

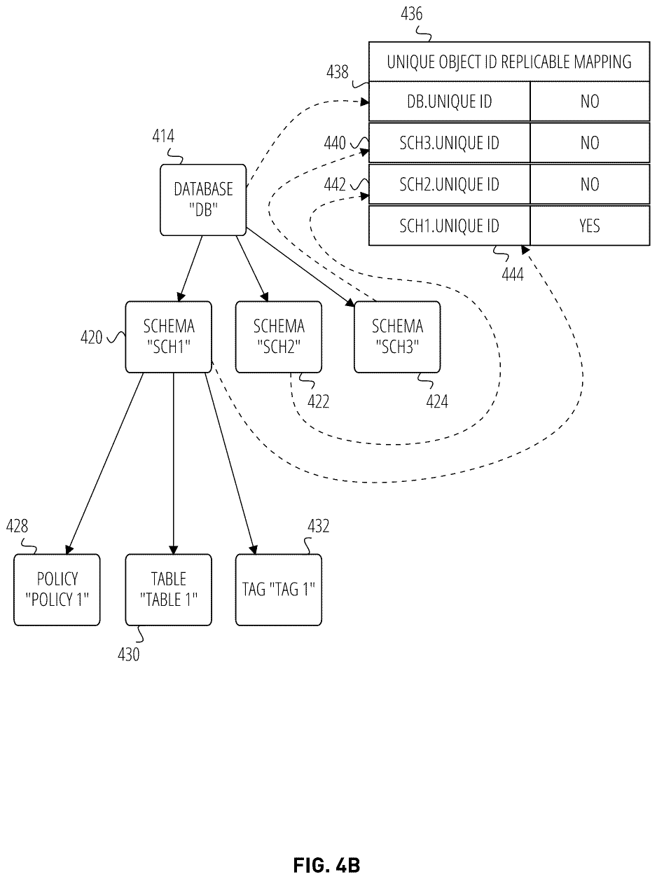

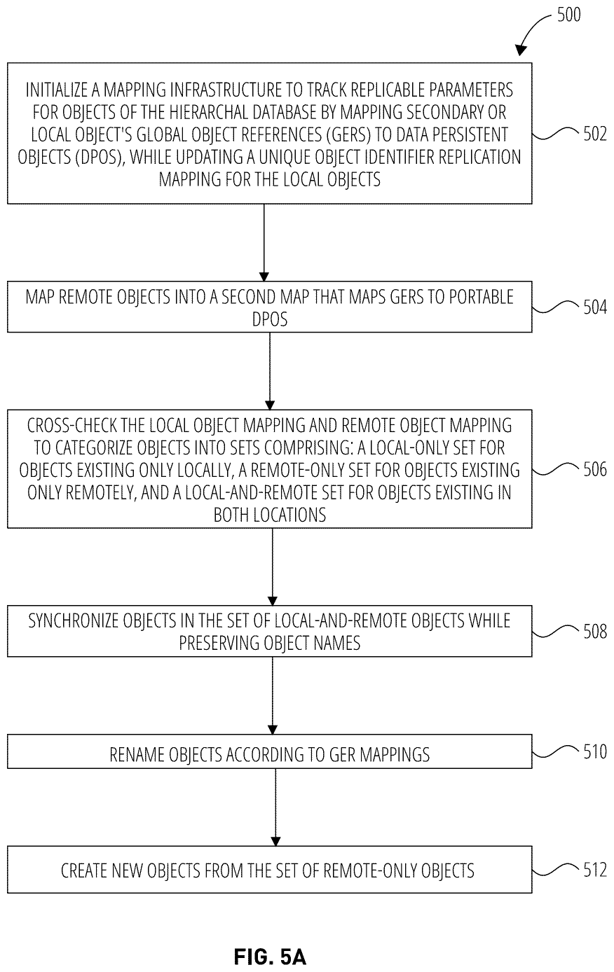

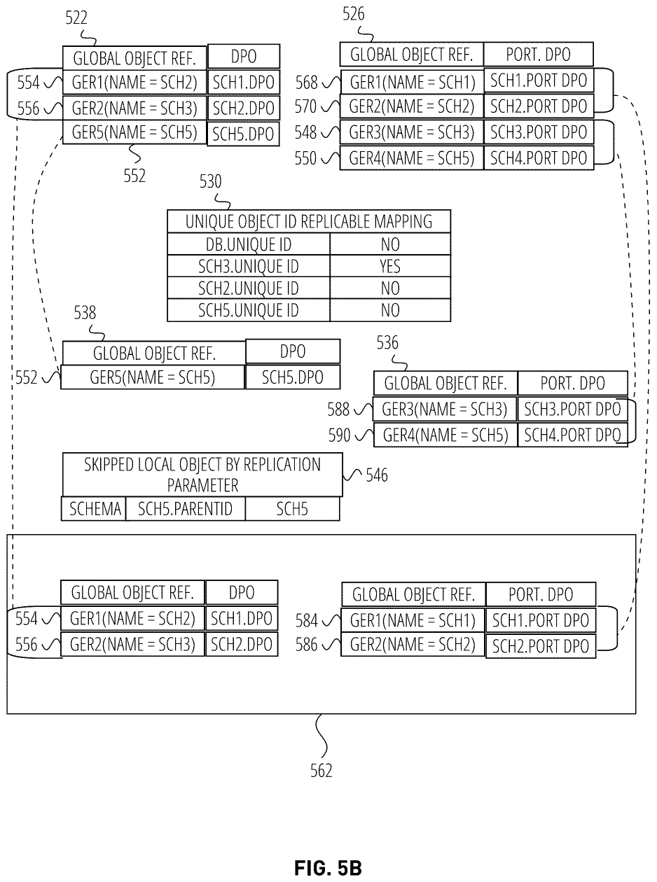

In operation 306, a replication engine 228 selectively replicates one or more database objects of the hierarchical database between accounts while maintaining data consistency during replication using the set of replicable parameters. For example, the replication engine 228 selectively replicates a set of objects includes replication of a first subset of child objects of the set of child objects within the hierarchical database while not replicating a second subset of the set of child objects of the hierarchical database as more fully described in reference to FIG. 4A, FIG. 4B, FIG. 5A, and FIG. 5B.

In some examples, a data platform restricts modification of a replicable parameter of the set of replicable parameters to database roles with account-level privileges. For example, the data platform implements access control for replication parameters through a an account-level privilege called REPLICATE. Only roles with this REPLICATE privilege can modify the replicable parameter values. In some examples, the data platform may provide this privilege to an account administrator role that can then grant the privilege to a replication administration role. This centralized privilege control ensures that schema and database owners cannot directly modify replication settings without proper authorization.

FIG. 4A and FIG. 4B illustrate an example primary-side replication method 400, according to some examples. The primary-side replication method 400 is used by a replication engine 228 (of FIG. 2) to prepare a snapshot of a primary database in a first account for copying to a secondary database in a second account. Although the example primary-side replication method 400 depicts a particular sequence of operations, the sequence may be altered without departing from the scope of the present disclosure. For example, some of the operations depicted may be performed in parallel or in a different sequence that does not materially affect the function of the primary-side replication method 400. In other examples, different components of data platform hat implements the primary-side replication method 400 may perform functions at substantially the same time or in a specific sequence.

In operation 402, the replication engine 228 stores in a domains supported list, domains that support sub-primary database replication using a set of replicable parameters. For example, the replication engine 228 stores domains that support sub-database replication in the domains supported list implemented as an immutable data structure. The domains supported list specifically includes identifiers of objects that can be replicated in accordance with a replicable parameter within a domain such as, but not limited to, a schema, a database, and the like, as the supported domains for sub-database replication.

In some examples, when visiting each object during replication, the replication engine 228 first checks if the object's domain exists in the domains supported list before attempting to acquire or set a replicable parameter of an object. In some examples, the replication engine 228 implements domain support validation through maintaining the domains supported list as a private static final field and using an immutable data structure creation process to create an unmodifiable list of supported domains.

In additional examples, the replication engine 228 coordinates this domain validation while working with other components like the metadata system 116 storing the metadata of a database and execution platform 110 to ensure proper replication behavior is only applied to supported database object types. This validation maintains the integrity of the replication process by ensuring that only appropriate database objects can participate in sub-database replication

In operation 404, the replication engine 228 generates a mapping of unique identifiers of a primary database and a set of child objects to respective replicable parameters of the set of replicable parameters. For example, the replication engine 228 generates a unique object ID replicable mapping data table 436 (of FIG. 4B) by creating a unique object ID to replicable mapping setting for an object mapping to map unique object ID of each object in a database 414 to its respective replicable parameter value. As an example, database “db” 414 has a db.unique ID 438 and its replicable parameter is set to NO. In a likewise manner, schema “sch1” 420 has a sch1.unique ID 444 and its replicable parameter is set to YES. Schema “sch2” 422 has a sch2.unique ID 442 and a replicable parameter set to NO. Schema “sch3” 424 has a sch3.unique ID 440 and its replicable parameter is set to NO. This mapping is used by the replication engine 228 to look up replicable parameter values during a database snapshot generation during a replication process. When visiting each object of the database “db” 414, the replication engine 228 implements the mapping by adding each visited object's unique ID and replicable parameter value to enable child object access. The mapping is used to determine inherited parameter values when a child object's replicable parameter value is undefined and maintains the mapping to track replicable parameter values and inheritance relationships between parent and child objects. This allows child objects to automatically inherit replication settings from their parents unless explicitly overridden.

The replication engine 228 uses the unique object ID replicable mapping data table 436 to track which objects have a replicable value set to YES vs NO, enable replicable parameter inheritance where child objects automatically inherit parent values unless explicitly overridden, support the replicable children count property by tracking how many child objects have a replicable parameter value set to YES, and determine whether to include objects in replication snapshots based on their parameter values.

In operation 406, the replication engine 228 visits each object of the primary database and determines whether a respective domain of the object supports sub-database replication. For example, the replication engine 228 implements a systematic process for visiting each object in the database “db” 414 to determine replication eligibility. When visiting each object, the replication engine 228 first checks if its domain exists in the domains supported list which specifically includes supported domains for sub-database replication.

In operation 408, the replication engine 228 acquires a replicable parameter for each visited object, wherein when the replicable parameter is undefined, the replication engine 228 obtains an inherited value from a parent object using the mapping of unique identifiers. For example, after confirming domain support, the replication engine 228 attempts to acquire the object's replicable parameter value. If the value is undefined (“NULL”), the replication engine 228 retrieves an inherited value from the unique object ID replicable mapping data table 436 using the unique object ID of the parent object of the child object currently being visited.

In operation 410, the replication engine 228 adds a unique identifier of each visited object and replicable parameter to the mapping of unique identifiers to enable child object access. For example, once a replicable parameter value is obtained for a new object, a new entry is added to the unique object ID replicable mapping data table 436 so subsequent child objects can access the replicable parameter value. This process ensures proper replication behavior by maintaining parameter inheritance throughout the object hierarchy.

As an example, the replication engine 228 visits the schema “sch1” 420 (of FIG. 4B) and adds sch3.unique ID 440 to the unique object ID replicable mapping data table 436 and determines that the replicable parameter value is set to YES. When visiting the child objects of schema “sch1” 420, namely policy “policy 1” 428, table “table 1” 430, and tag “tag 1” 432, the replication engine 228 will determine if the child object's domain is supported. If so, the replication engine 228 will attempt to obtain a replicable parameter value for the child object from the child object itself. If the child object does not have a replicable parameter value set, the replication engine 228 will use the replicable parameter value of schema “sch1” 420 as an inherited replicable parameter value for the child object.

In operation 412, the replication engine 228 selectively adds objects of the primary database to a replication snapshot based on a replicable parameter of each selected object. For example, the replication engine 228 follows a top-down approach, similar to traversing a tree from root to leaf nodes. The process begins with the replication engine 228 adding the database to the snapshot in accordance with the database's replicable parameter. The replication engine 228 then moves to all child objects, such as database roles and schemas. The engine selectively adds objects to the snapshot based on their replication parameter values. When an object's replicable parameter is set to NO and the object doesn't contain any child objects with a replicable parameter set to YES, the replication engine 228 will skip adding this object into the snapshot. This selective addition process ensures that only the desired database objects are included in the replication snapshot.

FIG. 5A and FIG. 5B illustrate an example secondary-side replication method 500, according to some examples. A replication engine 228 (of FIG. 2) uses the secondary-side replication method 500 to replicate a database from a primary database to a secondary database. The secondary-side replication method 500 is used in conjunction with the snapshot of a primary database generated by the primary-side replication method 400 of FIG. 4A. Although the example secondary-side replication method 500 depicts a particular sequence of operations, the sequence may be altered without departing from the scope of the present disclosure. For example, some of the operations depicted may be performed in parallel or in a different sequence that does not materially affect the function of the secondary-side replication method 500. In other examples, different components of a data platform that implements the secondary-side replication method 500 may perform functions at substantially the same time or in a specific sequence.

In operation 502, the replication engine 228 initializes a mapping infrastructure to track replicable parameters for objects of a hierarchal database by mapping secondary or local objects into a local object global object reference mapping 526 that maps Global Object References (GERs) to data persistent objects (DPOs), while updating a local object unique object ID to replicable value mapping table 530 for all local objects on the secondary side. For example, the replication engine 228 initializes the local object unique object ID to replicable value mapping table 530 at the secondary side to track replication parameter values for each local object on the secondary side. This mapping maps each local object's unique identifier to its corresponding replicable parameter value to control replication behavior during synchronization. The replication engine 228 uses this mapping when mapping local objects into the local object global object reference mapping 526 that associates GERs with DPOs. During this mapping process, the replication engine 228 updates the local object unique object ID to replicable value mapping table 530 with the replication parameter values of the local objects This allows the replication engine 228 to track which local objects should be preserved during synchronization based on their replication settings. When synchronizing databases between accounts, the replication engine 228 uses this mapping to determine whether local objects with a replicable parameter value set to NO should be preserved or overwritten based on conflict scenarios with remote objects.

In some examples, the local object unique object ID to replicable value mapping table 530 is used for handling the inheritance of replicable parameter values, where child objects inherit their parent's replicable parameter value unless explicitly overridden.

In operation 504, the replication engine 228 maps primary or remote objects into a remote object global object reference mapping 522 that maps GERS of the remote objects to portable DPOs. This mapping process creates a structured relationship between the remote objects' GERS and their portable data representations stored in a respective portable DPO.

In operation 506, the replication engine 228 cross-checks the local objects mapping and remote objects mapping to categorize objects into sets comprising: a set of local-only objects 536 for objects existing only locally, a set of remote-only objects 538 for objects existing only remotely, and a set of local-and-remote objects 562 for objects existing in both the primary or remote location and the secondary or local location. For example, the object identified by GER5 (name=sch5) 552 exists only remotely so it is included in the set of remote-only objects 538. The objects identified by GER3 (name=sch3) 548 and GER4 (name=sch5) 550 exist only in the secondary or local location so they are included in the set of local-only objects 536. The remote object GER1 (name=sch2) 554 corresponds (based on their GERs) to local object GER1 (name=sch1) 568, and remote object GER2 (name=sch3) 556 corresponds to local object GER2 (name=sch2) 570; therefore, these objects exist in both the primary or remote location and the secondary or local location so they are included in the set of local-and-remote objects 562.

In operation 508, the replication engine 228 synchronizes objects in the set of local-and-remote objects 562 while initially preserving object names. For example, the replication engine 228 copies the object identified as GER1 (name=sch2) 554 to object GER 1 (name=sch1) 584 but initially keeps the name “sch2” and does not use the name “sch1”. The replication engine 228 also copies the object GER2 (name=sch3) 556 to object GER2 (name=sch2) 586 but keeps the “sch3” name.

In operation 510, the replication engine 228 renames objects in the set of local-and-remote objects 562 according to the GER mappings in the local object global object reference mapping 526. For example, the replication engine 228 renames object GER1 (name=sch1) 584 from “sch2” to “sch1” and GER2 (name=sch2) 586 from “sch3” to “sch2” using the local object global object reference mapping 526.

In operation 512, the replication engine 228 creates new objects in the secondary or local location using the set of local-only objects 536. For example, the replication engine 228 creates object GER3 (name=sch3) 588 and object GER4 (name=sch5) 590 in the secondary or local location.

In some examples, the replication engine 228 maintains data consistency by preserving non-replicated objects of the hierarchal database during a failover replication. For example, the replication engine 228 does not replicate an object in the set of remote-only objects 538, such as by skipping 546 the replication of object GER5 (name=sch5) 552.

In some examples, local objects with a replicable parameter set to NO will not be replicated during replication except in certain cases. When there is a GER conflict with a remote object, a replication engine 228 will overwrite the local object even if it has replicable parameter set to NO. Specifically, if a local object shares the same GER as a remote object during synchronization, the local object will be overwritten by the remote object during replication, regardless of its replicable parameter being set to NO. This behavior occurs because the GER represents a unique global identifier that establishes the identity relationship between objects across different accounts. When two objects share the same GER, the replication engine 228 prioritizes maintaining global consistency over the local replicable parameter settings. This behavior ensures that objects with the same global identity maintain consistency across accounts, preventing potential conflicts or inconsistencies in the global object namespace.

In some examples, when there is a name conflict with newly created or renamed objects, the replication engine 228 handles the name conflict differently based on how the name conflict arises. For newly created objects, if a new object is created in a secondary database with the same name as an existing object in a primary database that has a replicable parameter set to NO, a failover job will fail. For example, if a secondary account creates a new object and sets a replicable parameter value to YES while the primary account has an existing object with the same name with a replicable parameter equal to NO, a failover job will fail, thus preventing the conflict.

In some examples, for renamed objects, if an object in a secondary account is renamed to match the name of an existing object in a primary account that has a replicable parameter set to NO, the refresh job will fail. For example, if a secondary account renames an object from “sch1” to “sch3” while the primary account has an existing object named “sch3” with a replicable parameter value set to NO, the refresh operation will fail. In all cases, the replication engine 228 prevents the replication operation rather than overwriting or modifying the existing objects with a replicable parameter set to NO. This behavior protects non-replicable objects from being affected by name conflicts while maintaining data consistency across accounts.

In some examples, objects having a replicable parameter values set to NO are preserved on the primary database account unless there are specific conflicts that can be resolved by overwriting. This preservation behavior differs from objects having a replicable parameter set to YES which are always overwritten during replication.

In some examples, the replication engine 228 replicates a database object without replicating a child object of the set of child objects when a replicable parameter of the database object indicates no replication is allowed and a replicable parameter of the child object indicates replication is allowed.

In some examples, the replication engine 228 replicates a child object when a replicable parameter of the child object indicates replication and a replicable parameter of a respective parent database object indicates no replication.

In some examples, the replication engine 228 maintains data consistency by resolving global object reference conflicts during replication.

In some examples, the replication engine 228 maintains data consistency by resolving name conflicts through a set of defined conflict resolution procedures

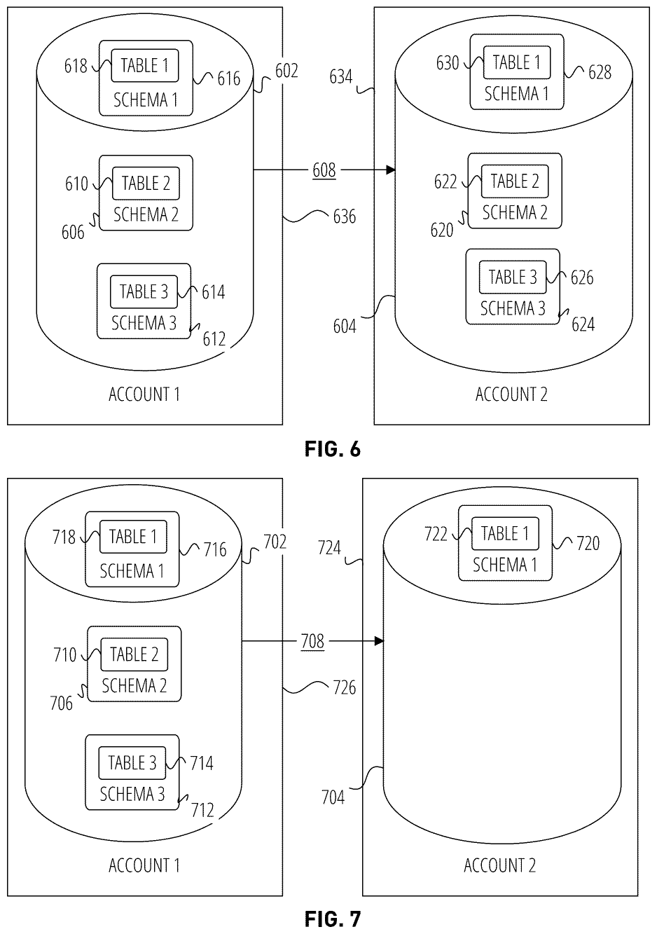

FIG. 6 illustrates a refresh property of replicable parameters, according to some examples. During a database refresh or a replication group refresh, if a database is replicated by the database replication or a replication group, then the parameter is not effective, thus the replicable parameter is only referenced during a failover operation. However, the replicable parameter values will be replicated in a replication group. In an example scenario, an account 1 636 has a primary database 602. The primary database 602 has a Schema 1 616 having a Table 1 618, a Schema 2 606 having a Table 2 610, and a Schema 3 612 and a Table 3 614. If a replicable parameter value of the primary database 602 is set to NO and a replicable parameter value of the Schema 1 616 is set to YES, during a database refresh or replication group refresh 608 of secondary database 604 in account 2 634, the primary database 602 and all of its child objects are used to refresh secondary database 604 and all of its child objects such as Schema 1 628 having Table 1 630, Schema 2 620 having Table 2 622, and Schema 3 624 having 626.

FIG. 7 illustrates a failover refresh property of replicable parameters, according to some examples. During a failover group refresh 708, a replication engine 228 (of FIG. 2) will only replicate objects with a replicable parameter value set to YES and will not replicate objects with replicable parameter value set to NO. For example, if a primary database 702 of Account 1 726 has a replicable parameter value set to NO, Schema 2 706 with Table 2 710 and Schema 3 712 with Table 3 714 will inherit a replicable parameter value of NO. Therefore, only Schema 1 716 with Table 1 718 having a replicable parameter value set to YES will be replicated as Schema 1 720 with Table 1 722 in secondary database 704 of Account 2 724.

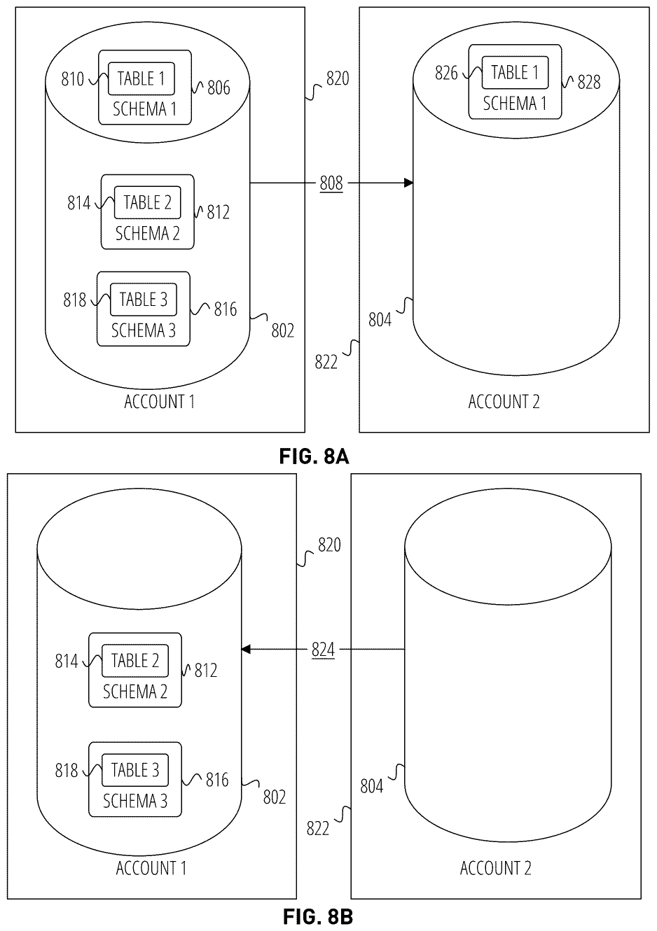

FIG. 8A and FIG. 8B illustrate a failover group refresh 808 and failover group refresh back 824 properties of replicable parameters, according to some examples. Local objects with replicable parameter values set to YES will be overwritten while local objects with replicable parameter values set to NO will not be overwritten except in some scenarios. For example, Account 1 820 includes a primary database 802 having schema 1 806 with table 1 810, schema 2 812 with table 2 814, and schema 3 816 with table 3 818. During a failover group refresh 808, schema 1 806 with table 1 810 is replicated as schema 1 828 with table 1 826 in secondary database 804 of Account 2 822 if the replicable parameter value of schema 1 806 is YES. Referring to FIG. 8A and FIG. 8B, after the failover group refresh 808, if schema 1 828 is dropped in Account 2 822, the failover group refresh back 824 will drop schema 1 806 in Account 1 820 but schema 2 812 and schema 3 816 with their respective tables will be kept.

In some examples, local objects with replicable parameter values set to NO but having a GER conflict are overwritten. It is possible for a local object to have a replicable parameter value set to NO while sharing the same GER as a remote object during the synchronization. In this case, even if the local object has a replicable parameter value set to NO, the local object will always be overwritten by the remote object.

In some examples, local objects having a replicable parameter value set to NO but having name conflicts will case a failover job to fail when the name conflict is caused by a newly created object.

In some examples, local objects having a replicable parameter value set to NO but having name conflicts will case a failover job to fail if the name conflict is caused by a rename operation of an existing local object.

In some examples, when a database has a replicable parameter value set to NO and no child object is labeled with replicable parameter value set to YES, the database will be replicated without any of its child objects.

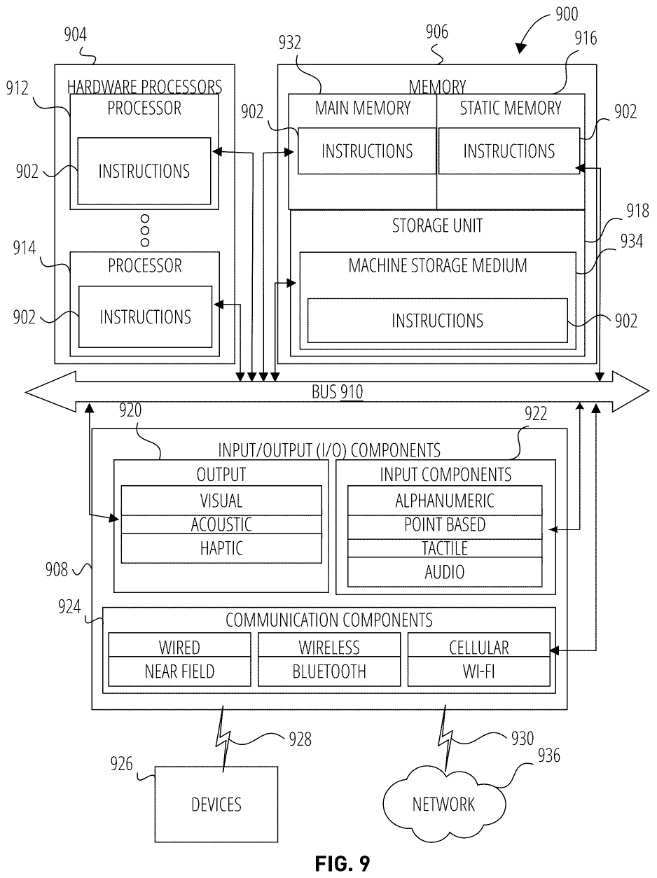

FIG. 9 illustrates a diagrammatic representation of a machine 900 in the form of a computer system within which a set of instructions may be executed for causing the machine 900 to perform any one or more of the methodologies discussed herein, according to examples. Specifically, FIG. 9 shows a diagrammatic representation of the machine 900 in the example form of a computer system, within which instructions 902 (e.g., software, a program, an application, an applet, an application, or other executable code) for causing the machine 900 to perform any one or more of the methodologies discussed herein may be executed. For example, the instructions 902 may cause the machine 900 to execute any one or more operations of any one or more of the methods described herein. In this way, the instructions 902 transform a general, non-programmed machine into a particular machine 900 (e.g., the compute service manager 104, the execution platform 110, and the data storage devices 108-1 to 108-N of data storage system 106) that is specially configured to carry out any one of the described and illustrated functions in the manner described herein.

In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 902, sequentially or otherwise, that specify actions to be taken by the machine 900. Further, while only a single machine 900 is illustrated, the term “machine” shall also be taken to include a collection of machines that individually or jointly execute the instructions 902 to perform any one or more of the methodologies discussed herein.

The machine 900 includes hardware processors 904, memory 906, and I/O components 908 configured to communicate with each other such as via a bus 910. In some examples, the hardware processors 904 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another hardware processor, or any suitable combination thereof) may include, for example, multiple processors as exemplified by processor 912 and a processor 914 that may execute the instructions 902. The term “processor” is intended to include multi-core processors that may comprise two or more independent processors (sometimes referred to as “cores”) that may execute instructions 902 contemporaneously. Although FIG. 9 shows multiple hardware processors 904, the machine 900 may include a single processor with a single core, a single processor with multiple cores (e.g., a multi-core processor), multiple processors with a single core, multiple processors with multiple cores, or any combination thereof.

The memory 906 may include a main memory 932, a static memory 916, and a storage unit 918 including a machine storage medium 934, accessible to the hardware processors 904 such as via the bus 910. The main memory 932, the static memory 916, and the storage unit 918 store the instructions 902 embodying any one or more of the methodologies or functions described herein. The instructions 902 may also reside, completely or partially, within the main memory 932, within the static memory 916, within the storage unit 918, within at least one of the hardware processors 904 (e.g., within the processor's cache memory), or any suitable combination thereof, during execution thereof by the machine 900.

The input/output (I/O) components 908 include components to receive input, provide output, produce output, transmit information, exchange information, capture measurements, and so on. The specific I/O components 908 that are included in a particular machine 900 will depend on the type of machine. For example, portable machines such as mobile phones will likely include a touch input device or other such input mechanisms, while a headless server machine will likely not include such a touch input device. It will be appreciated that the I/O components 908 may include many other components that are not shown in FIG. 9. The I/O components 908 are grouped according to functionality merely for simplifying the following discussion and the grouping is in NO way limiting. In various examples, the I/O components 908 may include output components 920 and input components 922. The output components 920 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 922 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 908 may include communication components 924 operable to couple the machine 900 to a network 936 or devices 926 via a coupling 930 and a coupling 928, respectively. For example, the communication components 924 may include a network interface component or another suitable device to interface with the network 936. In further examples, the communication components 924 may include wired communication components, wireless communication components, cellular communication components, and other communication components to provide communication via other modalities. The devices 926 may be another machine or any of a wide variety of peripheral devices (e.g., a peripheral device coupled via a universal serial bus (USB)). For example, as noted above, the machine 900 may correspond to any one of the compute service manager 104, the execution platform 110, and the devices 926 may include the data storage device 226 or any other computing device described herein as being in communication with the data platform 102 or the data storage system 106.

The various memories (e.g., 906, 916, 932, and/or memory of the processor(s) 904 and/or the storage unit 918) may store one or more sets of instructions 902 and data structures (e.g., software) embodying or utilized by any one or more of the methodologies or functions described herein. These instructions 902, when executed by the processor(s) 904, cause various operations to implement the disclosed examples.

Described implementations of the subject matter can include one or more features, alone or in combination as illustrated below by way of example.

Example 1 is a machine-implemented method for selective database replication, comprising: storing a hierarchical database including a database object and a set of child objects in a hierarchical parent-child structure; configuring a respective replicable parameter of a set of replicable parameters for the database and each child object within the hierarchical database; and selectively replicating a set of objects of the primary database between accounts of a data platform while maintaining data consistency during replication using the set of replicable parameters.

In Example 2, the subject matter of Example 1 includes, wherein a value of a replicable parameter of the set of replicable parameters can be set at a database level and a child object level.

In Example 3, the subject matter of any of Examples 1-2 includes, wherein the replicable parameter automatically propagates from a database to a child object of the set of child objects unless explicitly overridden at a level of the child object.

In Example 4, the subject matter of any of Examples 1-3 includes, wherein a child object of the set of child database objects inherits a value of a replicable parameter of the child object from the database when a replicable parameter of the database is set to a value.

In Example 5, the subject matter of any of Examples 1˜4 includes, wherein configuring the replicable parameter includes restricting modification of a replicable parameter of the set of replicable parameters to roles with account-level privileges.

In Example 6, the subject matter of any of Examples 1-5 includes, wherein selectively replicating a set of objects includes replication of a first subset of child objects of the set of child objects within the hierarchical database while not replicating a second subset of the set of child objects of the hierarchical database.

In Example 7, the subject matter of any of Examples 1-6 includes, wherein selectively replicating database objects comprises replicating a database object without replicating a child object of the set of child objects when a replicable parameter of the database object indicates no replication and a replicable parameter of the child object indicates replication.

In Example 8, the subject matter of any of Examples 1-7 includes, wherein selectively replicating database objects comprises replicating a child database when a replicable parameter of the child database object indicates replication and a replicable parameter of a respective parent database object indicates no replication.

In Example 9, the subject matter of any of Examples 1-8 includes, wherein maintaining data consistency comprises preserving non-replicated objects of the hierarchal database during a failover replication.

In Example 10, the subject matter of any of Examples 1-9 includes, wherein maintaining data consistency comprises resolving global object reference conflicts during replication.

In Example 11, the subject matter of any of Examples 1-10 includes, wherein maintaining data consistency comprises resolving name conflicts through a set of defined conflict resolution procedures.

In Example 12, the subject matter of any of Examples 1-11 includes, maintaining a count of child objects with replication enabled within the database; in response to determining the count of child objects is equal to zero, replicating the primary database without replicating any of the child objects of the set of child objects; and in response to determining the count of child objects is one or more, replicating the primary database while replicating one or more data objects of the set of data objects based on the set of replicable parameters.

In Example 13, the subject matter of any of Examples 1-12 includes, wherein: the set of replicable parameters control replication behavior during a failover replication operation and not during a refresh operation; and the set of replicable parameters are copied during the refresh operation.

In Example 14, the subject matter of any of Examples 1-13 includes, wherein maintaining data consistency further comprises: detecting a name conflict during a replication operation; and in response to the name conflict, preventing the replication operation.

In Example 15, the subject matter of any of Examples 1-14 includes, tracking replication parameter settings across the hierarchical database; providing visibility into inherited and explicit replication settings; and enabling management of replication configurations through centralized controls.

In Example 16, the subject matter of any of Examples 1-15 includes, wherein selectively replicating database objects further comprises: evaluating replication settings at each level of the hierarchical database; determining effective replication behavior based on inherited and local settings; and executing replication operations according to the determined behavior.

In Example 17, the subject matter of any of Examples 1-16 includes, storing, in a list, domains that support sub-database replication using a set of replicable parameters values; generating a mapping of unique identifiers of a primary database and a set of child objects to respective replicable parameters of a set of replicable parameters; visiting each object of the database and determining whether a respective domain of the object supports sub-database replication; acquiring a replicable parameter for each visited object, wherein when the replicable parameter is undefined, obtaining an inherited value from a parent object using the mapping of unique identifiers; adding a unique identifier of each visited object and replicable parameter to the mapping of unique identifiers to enable child object access; and selectively adding objects of the database to a replication snapshot based on a replicable parameter of each selected object.

In Example 18, the subject matter of any of Examples 1-17 includes, initializing a mapping infrastructure to track replicable parameters for objects of the hierarchal database by mapping secondary or local object's Global Object References (GERs) to Data Persistent Objects (DPOs) while updating a unique object identifier replication mapping for the local objects; mapping remote objects into a map that maps GERS to Portable DPOs; cross-checking the local object mapping and remote object mapping to categorize objects into sets comprising: a local-only set for objects existing only locally, a remote-only set for objects existing only remotely, and a local-and-remote set for objects existing in both locations; synchronizing objects in the set of local-and-remote objects while preserving object names; renaming objects according to the GER local object's GERs; and creating new objects from the set of remote-only objects.

Example 19 is at least one machine-readable medium including instructions that, when executed by processing circuitry, cause the processing circuitry to perform operations to implement any of Examples 1-18.

Example 20 is an apparatus comprising means to implement any of Examples 1-18.

Example 21 is a system to implement any of Examples 1-18.

Example 22 is a method to implement any of Examples 1-18.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various examples, one or more portions of the network 936 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 936 or a portion of the network 936 may include a wireless or cellular network, and the coupling 930 may be a Code Division Multiple Access (CDMA) connection, a Global System for Mobile communications (GSM) connection, or another type of cellular or wireless coupling. In this example, the coupling 930 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 902 may be transmitted or received over the network 936 using a transmission medium via a network interface device (e.g., a network interface component included in the communication components 924) and utilizing any one of a number of well-known transfer protocols (e.g., hypertext transfer protocol (HTTP)). Similarly, the instructions 902 may be transmitted or received using a transmission medium via the coupling 928 (e.g., a peer-to-peer coupling) to the devices 926. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 902 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

1. A machine-implemented method for selective database replication, comprising:
storing a hierarchical database including a database object and a set of child objects in a hierarchical parent-child structure;
configuring a respective replicable parameter of a set of replicable parameters for the database object and each child object of the set of child objects within the hierarchical database; and
selectively replicating a set of objects of the hierarchical database between accounts of a data platform, using the set of replicable parameters, while maintaining data consistency during replication, the selectively replicating comprising:
on a primary side, creating snapshots using a top-down traversal of the hierarchical database, selectively including objects based on their replication parameter values; and
on a secondary side, synchronizing objects by mapping global object references between accounts.

2. The machine-implemented method of claim 1, wherein a value of a replicable parameter of the set of replicable parameters can be set at a database level and a child object level.

3. The machine-implemented method of claim 2, wherein the replicable parameter automatically propagates from a database to a child object of the set of child objects unless explicitly overridden at a level of the child object.

4. The machine-implemented method of claim 2, wherein a child object of the set of child objects inherits a value of a replicable parameter of the child object from the database when a replicable parameter of the database is set to a value.

5. The machine-implemented method of claim 1, wherein configuring the replicable parameter includes restricting modification of a replicable parameter of the set of replicable parameters to roles with account-level privileges.

6. The machine-implemented method of claim 1, wherein selectively replicating a set of objects includes replication of a first subset of child objects of the set of child objects within the hierarchical database while not replicating a second subset of the set of child objects of the hierarchical database.

7. (canceled)

8. The machine-implemented method of claim 1, wherein selectively replicating database objects comprises replicating a child object when a replicable parameter of the child database object indicates replication and a replicable parameter of a respective parent database object indicates no replication.

9. The machine-implemented method of claim 1, wherein maintaining data consistency comprises preserving local objects having a replicable parameter set to NO of the hierarchal database during a failover replication.

10. The machine-implemented method of claim 1, wherein maintaining data consistency comprises resolving global object reference conflicts during replication.

11. A system comprising:
at least one processor; and
at least one memory storing instructions that, when executed by the at least one processor, cause the system to perform operations comprising:
storing a hierarchical database including a database object and a set of child objects in a hierarchical parent-child structure;
configuring a respective replicable parameter of a set of replicable parameters for the database object and each child object of the set of child objects within the hierarchical database; and
selectively replicating a set of objects of the hierarchical database between accounts of a data platform, using the set of replicable parameters, while maintaining data consistency during replication, the selectively replicating comprising:
on a primary side, creating snapshots using a top-down traversal of the hierarchical database, selectively including objects based on their replication parameter values; and
on a secondary side, synchronizing objects by mapping global object references between accounts.

12. The system of claim 11, wherein a value of a replicable parameter of the set of replicable parameters can be set at a database level and a child object level.

13. The system of claim 12, wherein the replicable parameter automatically propagates from a database to a child object of the set of child objects unless explicitly overridden at a level of the child object.

14. The system of claim 12, wherein a child object of the set of child objects inherits a value of a replicable parameter of the child object from the database when a replicable parameter of the database is set to a value.

15. The system of claim 11, wherein configuring the replicable parameter includes restricting modification of a replicable parameter of the set of replicable parameters to roles with account-level privileges.

16. The system of claim 11, wherein selectively replicating a set of objects includes replication of a first subset of child objects of the set of child objects within the hierarchical database while not replicating a second subset of the set of child objects of the hierarchical database.

17. (canceled)

18. The system of claim 11, wherein selectively replicating database objects comprises replicating a child object when a replicable parameter of the child database object indicates replication and a replicable parameter of a respective parent database object indicates no replication.

19. The system of claim 11, wherein maintaining data consistency comprises preserving local objects having a replicable parameter set to NO of the hierarchal database during a failover replication.

20. The system of claim 11, wherein maintaining data consistency comprises resolving global object reference conflicts during replication.

21. A machine-storage medium storing instructions that, when executed by one or more processors of a system, cause the system to perform operations comprising:
storing a hierarchical database including a database object and a set of child objects in a hierarchical parent-child structure;
configuring a respective replicable parameter of a set of replicable parameters for the database object and each child object of the set of child objects within the hierarchical database; and
selectively replicating a set of objects of the hierarchical database between accounts of a data platform, using the set of replicable parameters, while maintaining data consistency during replication, the selectively replicating comprising:
on a primary side, creating snapshots using a top-down traversal of the hierarchical database, selectively including objects based on their replication parameter values; and
on a secondary side, synchronizing objects by mapping global object references between accounts.

22. The machine-storage medium of claim 21, wherein a value of a replicable parameter of the set of replicable parameters can be set at a database level and a child object level.

23. The machine-storage medium of claim 22, wherein the replicable parameter automatically propagates from a database to a child object of the set of child objects unless explicitly overridden at a level of the child object.

24. The machine-storage medium of claim 22, wherein a child object of the set of child database objects inherits a value of a replicable parameter of the child object from the database when a replicable parameter of the database is set to a value.

25. The machine-storage medium of claim 21, wherein configuring the replicable parameter includes restricting modification of a replicable parameter of the set of replicable parameters to roles with account-level privileges.

26. The machine-storage medium of claim 21, wherein selectively replicating a set of objects includes replication of a first subset of child objects of the set of child objects within the hierarchical database while not replicating a second subset of the set of child objects of the hierarchical database.

27. (canceled)

28. The machine-storage medium of claim 21, wherein selectively replicating database objects comprises replicating a child object when a replicable parameter of the child database object indicates replication and a replicable parameter of a respective parent database object indicates no replication.

29. The machine-storage medium of claim 21, wherein maintaining data consistency comprises preserving local objects having a replicable parameter set to NO of the hierarchal database during a failover replication.

30. The machine-storage medium of claim 21, wherein maintaining data consistency comprises resolving global object reference conflicts during replication.
